(19) United States
(12) Patent Application Publication
(10) Pub. No.: US 2008/0302606 A1
(43) Pub. Date: Dec. 11, 2008

(54) Oil replacement system

(75) Inventor: Gerald Allen Alston, Union City, CA (US)

Correspondence Address: FOLEY AND LARDNER LLP;SUITE 500, 3000 K STREET NW, WASHINGTON, DC, 20007, US

(73) Assignee: Glacier Bay, Inc.

(21) Appl. No.: 11/808,377

(22) Filed: Jun. 8, 2007

(51) Int. Cl. F16N 29/00

(52) U.S. Cl. 184/6

(57) ABSTRACT

An oil replacement system for a vehicle can include oil quality sensor that directly determines the quality of the oil in the vehicle and sends an oil quality signal to a control system. Such an oil quality sensor can make a direct measurement of the quality of the oil in an engine oil system, thus permitting the oil replacement system to accurately determine the quality of oil in an engine oil system and whether the oil needs to be replaced.

The present invention generally relates to an oil replacement system for a vehicle.

### BACKGROUND

Conventional oil replacement systems include an electronically controlled oil replacement system that that adds oil to an engine oil system to compensate for oil leakage from the engine system and burning of oil in the engine system. Such oil replacement systems determine a need for oil by calculating the severity of the engine's operation. For example, a conventional oil replacement system may calculate the severity of an engine's operation based on a condition of the engine, such as a fuel consumption value, speed, rail pressure, exhaust temperature, oil temperature, or the grade of the oil used in the engine.

However, such conventional oil replacement systems do not directly determine the quality of the oil in the engine oil system because such oil replacement systems rely upon a calculation based upon engine operating conditions. Such calculations are not based upon direct measurements of the engine oil quality itself. Therefore, conventional oil replacement systems can produce a degree of error when calculating the severity of the engine's operation, causing the systems to inaccurately determine that the oil in an engine oil system needs to be replaced. As a result, existing oil replacement systems may operate to replace oil at improper intervals (i.e., too frequently or too frequently).

### SUMMARY

According to an embodiment, an oil replacement system for a vehicle comprises a supply of oil that is supplied to an engine of the vehicle, an oil addition device configured to add oil to the supply of oil, an oil removal device configured to remove oil from the supply of oil, an oil quality sensor configured to measure a quality of the supply of oil, and a controller, wherein the controller is configured to receive a oil quality signal from the oil quality sensor, wherein the controller is configured to determine if the quality of the supply of oil has degraded to a point below a predetermined threshold.

According to an embodiment, an oil replacement system for a vehicle comprises a supply of oil that is supplied to an engine of the vehicle, an oil addition device configured to add oil to the supply of oil, an oil removal device configured to remove oil from the supply of oil, an oil quality sensor configured to measure a quality of the supply of oil, and wherein the oil replacement system is configured to determine if the quality of the supply of oil has degraded to a point below a predetermined threshold on the basis of an oil quality signal provided by the oil quality sensor.

### BRIEF DESCRIPTION OF THE DRAWINGS

FIG. 1 is a schematic view of an oil replacement system, according to an embodiment.

FIG. 2 is a schematic view of an oil replacement system, according to another embodiment.

### DETAILED DESCRIPTION

Embodiments will now be described below with reference to the drawing. A non-limiting object of the embodiments described herein is to provide an oil replacement system for a vehicle, such as trucks, automobiles, and other vehicles. A further object of the embodiments described herein is to provide an oil replacement system that accurately determines when the oil of an engine oil system needs to be replaced.

The oil replacement system can include oil quality sensor that directly determines the quality of the oil in a vehicle and sends an oil quality signal to a control system. The oil replacement system can then determine if the oil needs to be replaced on the basis of the oil quality signal from the oil quality sensor. Such an oil quality sensor can make a direct measurement of the quality of the oil in an engine oil system. Therefore, such an oil replacement system can accurately determine the quality of oil in an engine oil system and whether the oil needs to be replaced. Therefore, the oil replacement system of the embodiments described herein can avoid the deficiencies of conventional oil replacement systems that rely upon indirect indications of oil quality, which can cause conventional oil replacement systems to replace oil before the oil has degraded in quality below an acceptable level or to not replace oil even when the oil has degraded in quality below the acceptable level.

In the past, estimation of oil quality was thought to be sufficient for ensuring proper vehicle operation and engine life. However, combining the direct oil quality sensing with an automated replacement system allows for optimization of the cost associated with oil replacement and the resulting benefits of extending engine life.

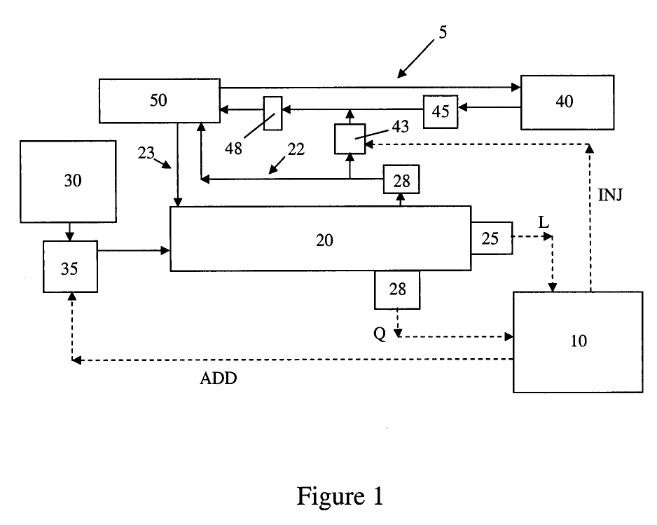

FIG. 1 shows a schematic view of an oil replacement system for a vehicle, according to an embodiment. The oil replacement system can include an oil sump or crankcase or storage unit 20 and an oil pump 28 that is configured to pump oil from the oil sump 20 to an engine 50 through an engine oil system 22. Oil can be pumped by the oil pump 28 through the engine oil system 22 to the engine 50 before being returned to the oil sump 20 through oil return line 23, as indicated in the example shown in FIG. 1. According to an embodiment, the oil in the oil sump 20 and the engine oil system 22 can be a supply of oil that is supplied to the engine 50. The oil sump 20 can include an oil level sensor 25.

The oil replacement system can include an auxiliary oil tank 30 that holds a supply of oil to be added to the oil sump 20 and engine oil system 22. An auxiliary oil control device 35 can be configured to control the timing and amount of oil additions to the oil sump 20. For example, the auxiliary oil control device 35 can be configured to add oil to the oil sump 20 and engine oil system 22 when it is determined that an oil addition is required. According to an embodiment, the auxiliary oil control device 35 is an oil addition device that is configured to add oil to a supply of oil that is supplied to the engine 50.

The oil replacement system can be configured to remove oil from the oil sump 20 and engine oil system 22. During the operation of an engine, the capacity for a supply of oil to cool and lubricate engine components diminishes as the quality of the oil degrades and the oil is contaminated. For example, the oil replacement system can be configured to remove oil from the oil sump 20 and engine oil system 22 when it is determined that the quality of oil has fallen below a predetermined threshold. According to an embodiment, such a predetermined threshold may correspond to quality of fuel necessary for maintaining proper cooling and/or lubrication of engine components. Therefore, the oil replacement system can provide a way of automatically changing the oil in an engine oil system without requiring engine downtime. Furthermore, the oil replacement system can be configured to maintain an oil concentration in the fuel below a predetermined level necessary to maintain exhaust emissions within acceptable limits.

The oil replacement system can be configured to remove oil from the engine oil system 22, such as when the quality of the oil has diminished to a point below a predetermined threshold. According to an embodiment, the oil replacement system can be configured to remove oil from the engine oil system 22 by injecting a controlled quantity of oil into an engine fuel system 5 for combustion of the oil with the engine fuel. For example, the oil replacement system can include an injection device 43 that is configured to inject a controlled quantity of oil into an engine fuel system 5. According to an embodiment, the injection device 43 can be an oil removal device that is configured to remove oil from a supply of oil that is supplied to the engine 50.

An engine fuel system 5 can include a fuel tank 40 and a fuel pump 45 that is configured to pump fuel from the fuel tank 40 to an engine 50, as shown in the example of FIG. 1. Any unused fuel can then be returned from the engine 50 to the fuel tank 40, as shown in the example of FIG. 1. According to a further embodiment, the engine fuel system 5 can include a fuel filter 48. The fuel filter 48 can be positioned in the line supplying fuel to the engine 50, as shown in the example of FIG. 1.

The injection device 43 can be configured to inject a controlled quantity of oil into the fuel being supplied to the engine 50, such as upstream of a fuel filter 48, or into the fuel being returned from the engine 50 to the fuel tank 40.

The devices described above can be configured as described Graham et al. in U.S. Pat. No. 6,082,322, which is incorporated herein by reference in its entirety, and by Marsh et al. in U.S. Pat. No. 6,213,080, which is incorporated herein by reference in its entirety.

According to an embodiment, the oil replacement system can include a controller 10 that is configured to control various functions of the oil replacement system. For example, the controller 10 can be configured to control the oil control device 35 by sending a signal ADD to the oil control device 35. The ADD signal can indicate that a controlled amount of oil must be added to the oil sump 20. Upon receiving the signal ADD, the oil control device 35 can operate to add a controlled amount of oil from the auxiliary oil tank 30 to the oil sump 20, thus supplying fresh oil to the oil sump 20 and engine oil system 22.

According to a further embodiment, the controller 10 can be configured to issue an addition signal ADD when the controller 10 determines that oil needs to be added to the oil sump 20 and engine oil system 22. For example, the controller 10 can be configured to issue an addition signal ADD when the controller 10 determines that the level of oil in the oil sump 20 is low, when the controller 10 controls the oil replacement system to remove oil from the engine oil system 22, and/or when the controller 10 determines that the quality of oil in the oil sump 20 and engine oil system 22 has diminished to a point below a predetermined threshold.

According to an embodiment, the controller 10 can be configured to control the injection device 43 by sending a signal to the injection device 43. For example, the controller 10 can be configured to send a signal INJ to the injection device 43. Such a signal INJ can instruct the injection device 43 to perform an operation to remove a controlled quantity of oil from the engine oil system 22 and inject the oil into the engine fuel system 5. Upon receiving the signal INJ, the injection device 43 can operate to remove a controlled amount of oil from the engine oil system 22, thus removing oil from the engine oil system 22 that has been degraded in quality and/or contaminated during operation of the engine.

According to a further embodiment, the controller 10 to issue an injection signal INJ when the controller 10 determines that oil needs to be removed from the engine oil system 22. For example, the controller 10 can be configured to issue an injection signal INJ when the controller 10 determines that the level of oil in the oil sump 20 is too high, when the controller 10 controls the oil replacement system to add oil to the oil sump 20 and engine oil system 22, and/or when the controller 10 determines that the quality of oil in the oil sump 20 and engine oil system 22 has diminished to a point below a predetermined threshold.

According to an embodiment, the controller 10 can be configured to receive a signal from an oil level sensor 25 that is mounted to the oil sump 20. For example, the oil level sensor 25 can be configured to provide a signal L to the controller 10 indicating the level of oil in the oil sump 20. According to a further embodiment, the controller 10 can be configured to determine if the level of oil in the oil sump 20 is too low or too high on the basis of signal L.

According to an embodiment, the controller 10 can be configured to receive a signal from an oil quality sensor 28 that is mounted to the oil sump 20. For example, the oil quality sensor 28 can be configured to provide a signal Q to the controller 10 indicating the quality of oil in the oil sump 20 and the engine oil system 22. According to a further embodiment, the controller 10 can be configured to determine if the oil in the oil sump 20 and the engine oil system 22 has degraded in quality and/or been contaminated to a point below a predetermined threshold.

According to a further embodiment, the oil quality sensor 28 may alternatively be positioned in the engine oil system 22 to determine the quality of oil flowing in the engine oil system 22. According to another embodiment, an additional oil quality sensor 28 may be positioned in the engine oil system 22 so that the controller receives a signal from an oil quality sensor 28 that is mounted to the oil sump 20 and a signal from an oil quality sensor 28 that is positioned in the engine oil system 22.

By providing an oil quality sensor 28 that directly determines the quality of oil in the oil sump 20 and the engine oil system 22, the oil replacement system can be configured to accurately determine if the oil needs to be replaced on the basis of a signal from the oil quality sensor 28. Therefore, the oil replacement system can accurately determine the quality of oil in an oil sump 20 and engine oil system 22 and determine whether the oil needs to be replaced. Such an oil replacement system can avoid the deficiencies of conventional oil replacement systems that rely upon indirect indications of oil quality, which can cause conventional oil replacement systems to replace oil before the oil has degraded in quality below an acceptable level or cause conventional oil replacement system to not replace oil even when the oil has degraded in quality below the acceptable level.

According to a further embodiment, the oil quality sensor 28 can be configured to determine the quality of oil by measuring the electrical conductivity of the oil. For example, the oil quality sensor 28 can have a design as described by Heremans et al. in U.S. Pat. No. 6,911,830, which is hereby incorporated by reference in its entirety.

According to a further embodiment, the oil quality sensor 28 can be configured to determine the quality of oil by measuring a dielectric coefficient of the oil. For example, the oil quality sensor 28 can have a design as described by Collister in U.S. Pat. No. 6,459,995, which is hereby incorporated by reference in its entirety, or a design as described by Schoess in U.S. Pat. No. 6,718,819, which is hereby incorporated by reference in its entirety.

According to a further embodiment, the oil replacement system can further include a indicator in the dashboard of the vehicle that is configured to signal a driver of the vehicle that the vehicle needs to be serviced to replenish or replace oil. For example, the controller 10 can be configured to send a signal to the indicator when the controller 10 determines that the supply of oil in the auxiliary oil tank 30 is too low or when the oil in the oil sump 20 and the engine oil system 22 needs to be completely replaced.

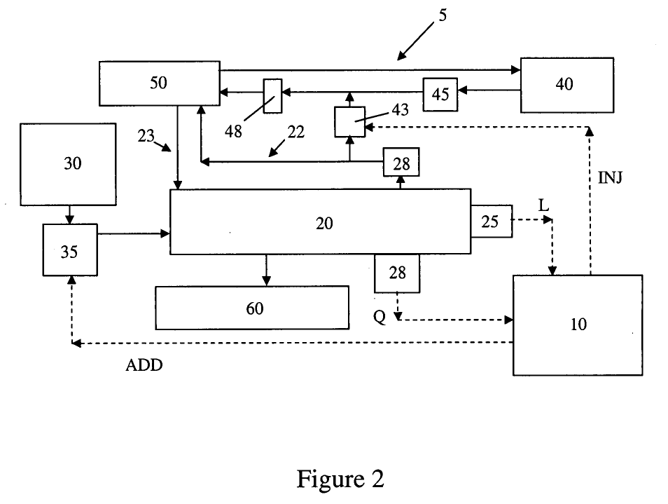

FIG. 2 shows a schematic view of an oil replacement system according to another embodiment. The oil replacement system shown in the example of FIG. 2 can include any of the features and embodiments described above in regard to FIG. 1. Furthermore, the oil replacement system can include a tank 60 that is configured to collect oil from the oil sump 20 and/or the engine oil system 22. For example, the oil replacement system can be arranged so that the entire supply of oil in the oil sump 20 and/or the engine oil system 22 can be removed and diverted into the tank 60. The tank 60 can be configured to store the oil until the vehicle can be serviced and the oil removed from the tank 60.

According to a further embodiment, an oil replacement system can be configured to include a tank 60 in addition to the features described above in regard to FIG. 1. Therefore, the oil replacement system can be configured to replace oil gradually over time, or the oil replacement system can replace an entire supply of oil in the oil sump 20 and/or engine oil system 22 at once.

According to a further embodiment, the tank 60 can include a device for diverting oil from the oil sump 20 and/or engine oil system 22 to the tank 60. For example, the tank 60 could include a valve that is automatically controlled by the controller 10. Such an oil diverting device can be separate and independent from the injection device 43 described above. According to another embodiment, the device for diverting oil to the tank 60 can be integral to the injection device 43 or the injection device 43 can be configured to also divert the entire supply of oil in the oil sump 20 and/or engine oil system 22 to the tank 60.

According to a further embodiment, the oil control device 35 can be configured to provide a fresh supply of oil to the oil sump 20 and engine oil system 22 when the oil is diverted from the oil sump 20 and/or engine oil system 22. According to a further embodiment the auxiliary oil tank 30 can be configured to hold a quantity of oil sufficient to completely replace the oil diverted from the oil sump 20 and/or the engine oil system 22 to the tank 60.

According to a further embodiment, the oil replacement system can be configured so that oil is diverted to the tank 60 when the oil quality sensor 28 determines that the oil in the oil sump 20 and the engine oil system 22 has degraded in quality and/or been contaminated to a point below a predetermined threshold, as described in the any of the embodiments above.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. An oil replacement system for a vehicle, comprising:
a supply of oil that is supplied to an engine of the vehicle,
an oil addition device configured to add oil to the supply of oil,
an oil removal device configured to remove oil from the supply of oil,
an oil quality sensor configured to measure a quality of the supply of oil, and
a controller, wherein the controller is configured to receive a oil quality signal from the oil quality sensor,
wherein the controller is configured to determine if the quality of the supply of oil has degraded to a point below a predetermined threshold.

2. The oil replacement system of claim 1, wherein the controller is configured to instruct the oil addition device to add a controlled amount of oil to the supply of oil when the controller determines that the quality of the supply of oil has degraded to a point below the predetermined threshold.

3. The oil replacement system of claim 1, wherein the controller is configured to control the oil removal device to remove a controlled amount of oil from the supply of oil when the controller determines that the quality of the supply of oil has degraded to a point below the predetermined threshold.

4. The oil replacement system of claim 3, wherein the oil removal device is configured to inject the controlled amount of oil into an engine fuel system of the vehicle.

5. The oil replacement system of claim 1, further comprising an oil level sensor that is configured to measure a level of oil in the supply of oil,
wherein the controller is configured to received a signal from the oil level sensor indicated the level of oil.

6. The oil replacement system of claim 5, wherein the controller is configured to control the oil addition device to add a controlled amount of oil when the controller determines that the level of oil in the supply of oil is too low.

7. The oil replacement system of claim 5, wherein the controller is configured to control the oil removal device to remove a controlled amount of oil when the controller determines that the level of oil in the supply of oil is too high.

8. The oil replacement system of claim 1, wherein the oil quality sensor is mounted to an oil sump of the vehicle.

9. The oil replacement system of claim 8, further comprising a second oil quality sensor that is positioned in an engine oil system of the vehicle.

10. The oil replacement system of claim 1, wherein the oil quality sensor is positioned in an engine oil system of the vehicle.

11. The oil replacement system of claim 1, wherein the oil quality sensor is configured to measure the electrical conductivity of the oil.

12. The oil replacement system of claim 1, wherein the oil quality sensor is a capacitance sensor.

13. The oil replacement system of claim 1, wherein the oil quality sensor is configured to measure a dielectric constant of the oil.

14. The oil replacement system of claim 1, further comprising a tank that is configured to receive the supply of oil,
wherein the oil replacement system is configured to replace all of the supply of oil by diverting all of the supply of oil into the tank and supplying a fresh supply of oil.

15. An oil replacement system for a vehicle, comprising:
a supply of oil that is supplied to an engine of the vehicle,
an oil addition device configured to add oil to the supply of oil,
an oil removal device configured to remove oil from the supply of oil,
an oil quality sensor configured to measure a quality of the supply of oil, and
wherein the oil replacement system is configured to determine if the quality of the supply of oil has degraded to a point below a predetermined threshold on the basis of an oil quality signal provided by the oil quality sensor.
